(19) United States
(12) Patent Application Publication
(10) Pub. No.: US 2001/0032142 A1
(43) Pub. Date: Oct. 18, 2001

(54) Bidirectional optimum transaction method for multiple customers by internet

(76) Inventors: Hong-Chul Jeon, Seoul (KR); Won-Bae Lee, Keongki-do (KR); Sang-Chul An, Seoul (KR); Tai-Jin Jung, Seoul (KR)

Correspondence Address: COATS & BENNETT, PLLC, P O BOX 5, RALEIGH, NC, 27602, US

(21) Appl. No.: 09/750,586

(22) Filed: Dec. 28, 2000

(30) Foreign Application Priority Data
Apr. 18, 2000 (KR) 2000-20311

(51) Int. Cl. G06F 17/60

(52) U.S. Cl. 705/26

(57) ABSTRACT

The present invention is directed to an E-to-E (End to End) Internet transaction method of the B-to-B (Business to Business). In the method that has been previously described and according to the drawings and the related art of present invention, a vendor and a customer both provide a proposal and a selection. In the conventional, Internet transaction system, a certain transaction is suggested by one of the vendors exclusively, and, then, the customer is provided.

Namely, the present invention is directed to a method capable of implementing a transaction based on the optimum conditions. The E-to-E Internet transaction requires that the transaction be a stable and continuous, it is not a one-time transaction. Therefore, in the present invention, it is possible to prevent dumping, due to either over competition and an over margin on the part of the supplier. The method, according to drawings and the related art of the present invention, satisfies both vendor and customer based on multiple vendor and multiple customer scenarios and situations.

The transaction is implemented based on an on-line document, so that it is possible to simplify the transaction procedure for all transaction procedures and document transaction procedures, thereby, decreasing the overall cost.

The end results are the customers and vendors, who are satisfied with stable and low cost transactions.

### BACKGROUND OF THE INVENTION

1. Field of the Invention

The present invention relates to an E-to-E (End To End) electronic transaction method for a B-to-B (Business To Business) Internet service, and, in particular, to an electronic transaction method which is not only bi-directional, but also capable of optimizing transactions for multiple customers.

The method is capable of providing not only a transaction proposal to both a vendor and to a customer, but also the means by which a vendor and a customer can select the proposal. These features effectively prevent outside parties from dumping additional conditions on a transaction proposal, due to over competition. Under this method, transaction conditions are provided by a large variety of vendors and by a wide variety of potential customers. From among a plurality of these vendors and a plurality of these potential customers, specific customers and specific vendors are free to select conditions that fully satisfy each other, respectively.

2. Description of the Background Art

The electronic (Internet) transaction has been significantly enhanced and improved by using an Internet system. The method is designed to be implemented when a vendor provides an item on the Internet and a customer purchases the item from the Internet using an electronic (Internet) transaction.

In conventional electronic transaction systems, since there are either too many items provided by vendors, or there are too many items that customers wish to buy; it is almost impossible to close a proper transaction between customer(s) and vendor(s) at a proper price. This critical problem with conventional transaction systems is in the absence of a traceable method, which would make it possible to negotiate the optimizing transactions between a multiple number of vendors and a multiple number of the buyers. Due to over competition or to some form of pre-arranged bidding, a vendor's item could be either over or under margin. The item could be either over or under-priced as well.

### SUMMARY OF THE INVENTION

Accordingly, one of the objectives of the present invention is to provide a bi-directional optimum transaction method for multiple customers, which overcomes the problems encountered in the conventional art.

Another objective of the present invention is to provide a bi-directional optimum transaction method for multiple customers, which is capable of effectively preventing outside parties from dumping additional conditions on an E-to-E electronic transaction proposal, which requires stability.

An additional objective of the present invention is to provide a bi-directional optimum transaction method for multiple customers which is capable of preventing an over margin from occurring, for any reason, in an E-to-E electronic transaction. If they are to be a success, these kinds of transactions require stability.

The final objective of the present invention is to provide a bi-directional optimum transaction method for multiple customers that have the capability to lower the costs of transactions, to provide items at a lower price, and to maintain stable transactions for all customers.

In order to achieve the above objectives, a bi-directional optimum transaction method for multiple customers is provided. The method is comprised of:

(1) A customer ordering step for inputting the buyer's information with respect to purchasing a certain item at a proper price and for providing the buyer's information into the transaction system.

(2) A vendor ordering step for inputting a vendor's information with respect to vending a certain amount of the items at a certain price and providing the vending ordering information into the transaction system.

(3) A customer-based transaction step for searching the vending information which corresponds the most to a buyer's conditions i.e. kinds, amount, delivery state, delivery time, delivery location, price, etc . . . on an item that a customer wishes to buy and showing the information which most closely matches the previous information in the searched results part of the program, and finally determining an item transaction, on the part of the customer, with respect to the buyer's information; thereby implementing a transaction.

(4) A vendor-based transaction step for searching purchasing preferences, from a variety of potential customers, that come the closest to corresponding to conditions; such as kinds, amount, delivery state, delivery time, delivery location, price, etc . . . of a certain item being offered by the vendor, then, showing the information which corresponds the most to the vendor's conditions in the searched results part of this program, and finally, determining an item transaction that is specifically in keeping with the purchasing information of the vendor; thereby implementing a transaction.

(5) A customer-based consignment step for authorizing and initiating a payment plan, based on item(s) and price(s), after the transaction.

(6) A vendor-based consignment step for assigning an item or items for either delivery, or for transaction cancellation, based on the amount of the money consigned by the customer.

(7) A customer-based transportation step for delivering the item, after the transaction has been implemented, and the money, corresponding to the price of the item(s) has been consigned.

(8) A vendor-based transportation step for delivering the item, after the transaction is implemented, and the money, corresponding to the price of the item, has been consigned.

(9) A transportation/freight-based delivery step, when the money for the item or items in the transaction has already been consigned, but the customer/vendor does not have his/her own means of transportation.

Additional objectives, advantages and features of the invention will be- come more apparent from the description as follows:

### BRIEF DESCRIPTION OF THE DRAWINGS

The present invention will become more fully understood from the detailed description given herein. The accompanying drawings, which are given by way of illustration only, are not to be considered as limitations of the present invention. Therefore, wherein and according to the drawings of the present invention:

FIG. 1 is a flow chart of a customer- ordering step according to the present invention;

FIG. 2 is a flow chart of a vendor-ordering step according to the present invention;

FIG. 3 is a flow chart of a customer-based transaction step according to the present invention;

FIG. 4 is a flow chart of a vendor-based transaction step according to the present invention;

FIG. 5 is a flow chart of a customer-based consignment step according to the present invention;

FIG. 6 is a flow chart of a vendor-based consignment step according to the present invention;

FIG. 7 is a flow of a customer-based transportation step according to the present invention;

FIG. 8 is a flow chart of a vendor-based transportation step according to the present invention; and

FIG. 9 is a flow chart of a transporter-based transportation step according to the present invention.

### DETAILED DESCRIPTION OF THE PREFERRED EMBODIMENTS

The bi-directional optimum transaction steps for multiple customers according to the present invention will be explained with reference to the accompanying drawings.

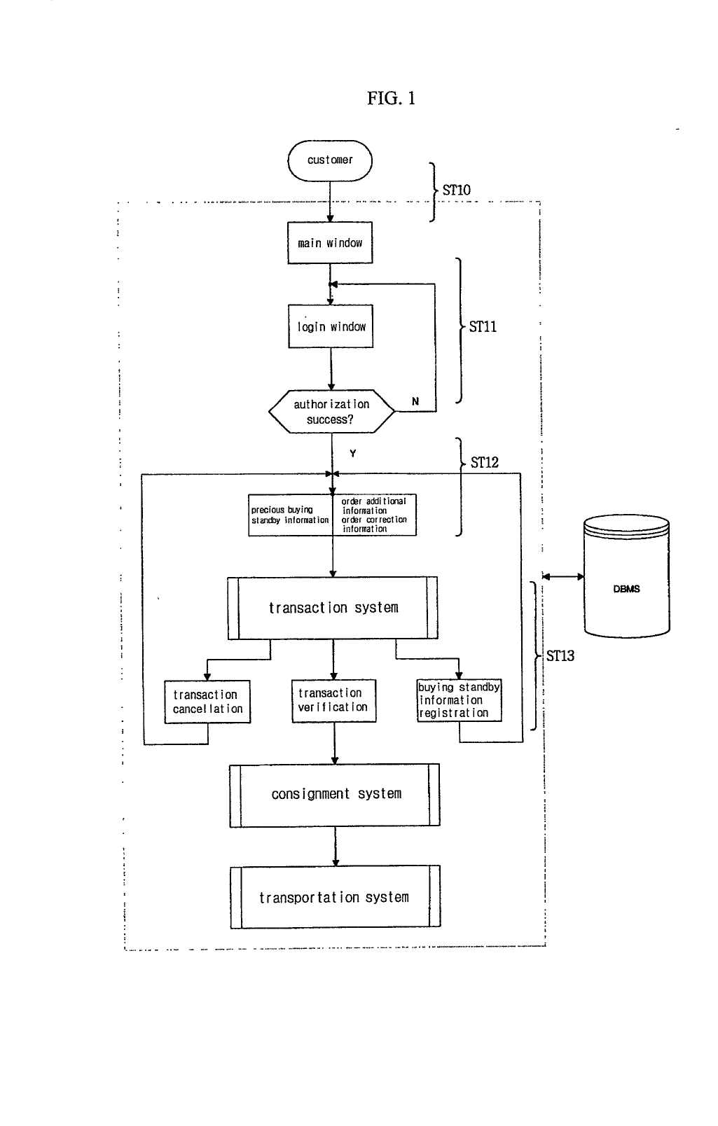

FIG. 1 is a flow chart of the customer- ordering step, according to the drawings and the related art of the present invention. As shown therein, the customer ordering step allows customers, who desire to purchase a desired item at an acceptable price, to input purchasing/buying information into to the transaction system.

The above includes the following steps:

ST10—a customer registers to become a member by using one of the main screens of the system.

ST11—a customer/member logs-in to the system using a verified ID, a password, a verified card, etc . . . for inputting purchasing/buying information.

ST12—a customer/member inputs the desired item, the price of the item, the exact number of the items, the preferred date upon which to either purchase or buy the item(s), and the desired transportation method, and, then, inputting the ordering information of a customer, or the customer's inquiry, modifications, and deletions of any previously inputted purchasing/buying information.

ST13—(a) conducting a system-wide search for a proper vendor, based on the purchasing/buying information inputted by the customer/member, in order to complete an item transaction, (b) changing purchasing/buying information when a customer either fails to buy a desired item which is in the transaction system (failed transaction) or cancels the transaction. When failed transactions occur, the purchasing/buying information remains stored in the system, until a transaction takes place on an item which satisfies the desired condition(s) i.e., standby buying information registration.

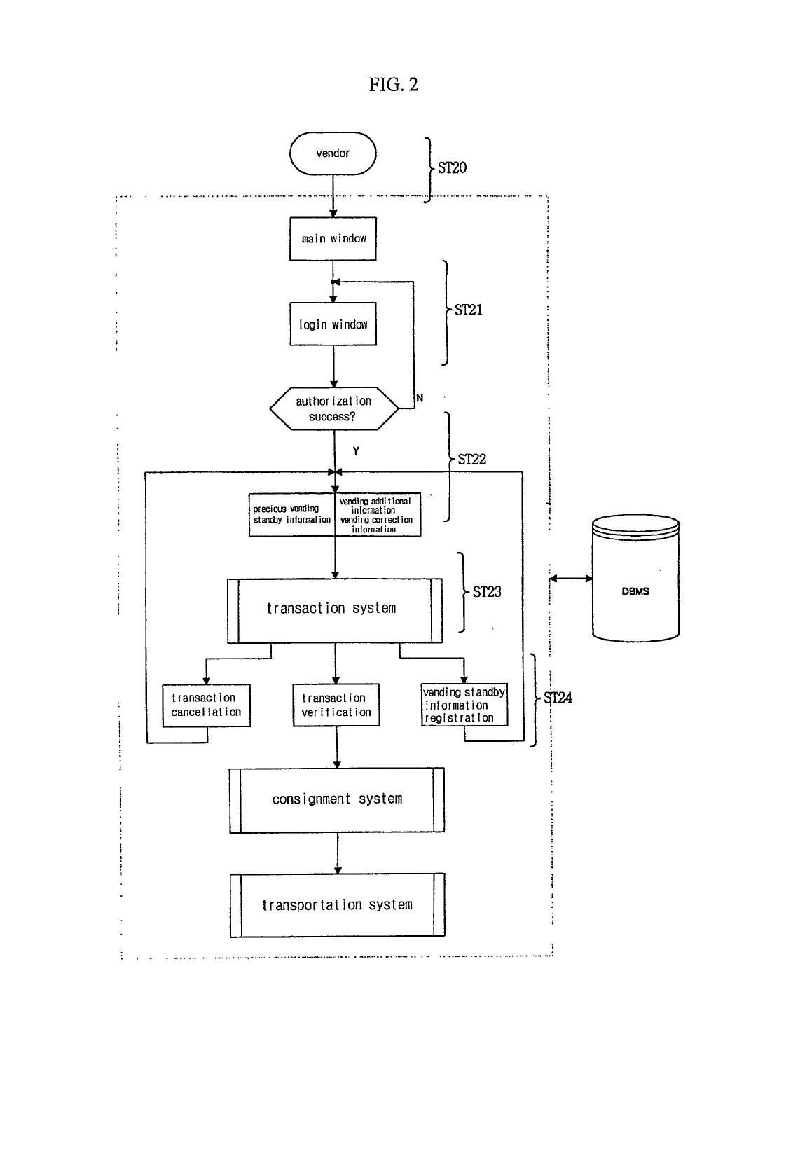

FIG. 2 is a flow chart of the vendor-based ordering step, according to the drawings and the related art of the present invention. As shown therein, the vendor-based ordering step directs a user to a system capable of inputting vendor information, with respect to a particular item, and providing ordering information from a vendor or vendors to the transaction system for supplying a certain amount of the items for an acceptable price.

The vendor-based ordering step described above includes the following steps:

ST20—vendor registration.

ST21—for vendors to log-in using a verified ID, a password, and a verification card for inputting sale order information.

ST22—for the input of price, amount of item(s), delivery time, based on the item and the method of transportation for delivering the items, sale order information of the vendor conducting a system-wide search, modifying the ordering informa-tion, and deleting the ordering information; based on any previous standby sale information that had been registered in the system.

ST23—to help vendors search for a proper customer or customers, based on the condition(s) inputted by a vendor for implementing a transaction.

ST24—for modifying or for canceling (transaction cancellation) in cases when the item has not been sold, based on the condition(s) set for that item in the transaction system, and for storing sale information in the system until the purchasing/buying information, which does satisfy the necessary condition(s), is provided by the transaction system (vendor standby information registration).

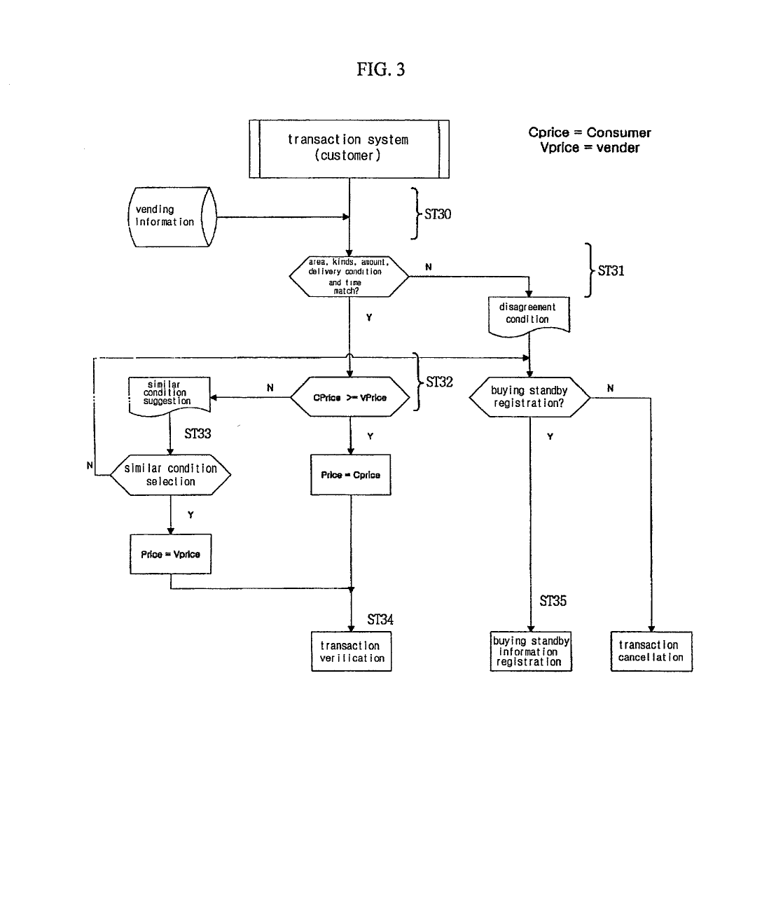

FIG. 3 is a flow chart of the customer-based transaction step, according to the drawings and the related art of the present invention. As shown therein, the customer-based transaction step searches for information that most closely matches conditions, such as item, amount of item(s), means of delivery, delivery time, price, etc . . . that have been set for the customer's desired item. Then, the information is clearly displayed and shown to the customer, in order to help the customer select the type of transaction desired with respect to the vendor information that has been provided by the system.

The customer-based transaction step includes the following steps:

ST30—for searching other conditions within either the system or the standby list, which are in agreement with the conditions desired by the customer; except for the price.

ST31—for showing the condition of non-coincident information in cases when none of the standby items match with the condition(s) of step ST30.

ST32—for implementing the transaction when the customer's condition(s) and the vendor's condition(s) i.e., customer price and vendor price, are matched in step ST30, and for excluding the previously transacted company in case there are a plurality of vendors.

ST33—for assisting the customer with providing the vendor information of the next candidate in cases where acceptable conditions have not been provided by the system.

ST34—for finalizing and validating a transaction in cases when the customer is satisfied with a new or similar condition or new and similar conditions.

ST35—for registering onto a standby purchasing/buying information list of the system, and for canceling a purchasing/buying request, in cases when the customer does not satisfy the requirements of the new or similar condition(s).

In addition, the transaction is implemented when the vendor information, which most satisfies the purchasing/buying condition, is provided, and the standby buying information is valid up to and including the customer's desired delivery period (time). The information is deleted automatically, after these previous conditions have been completed, implemented and validated by the system.

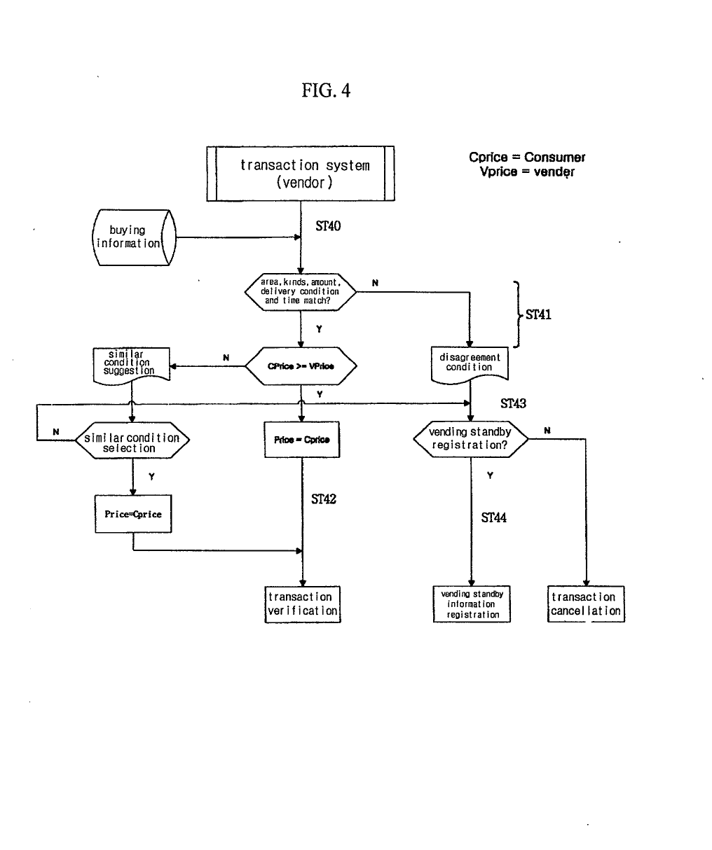

FIG. 4 is a flow chart of a vendor-based transaction step, according to the drawings and the related art of the present invention. As shown in the vendor-based transaction system, the purchasing/buying information, which most satisfies the vendor's conditions, such as kinds, amount, delivery means, delivery time, price, etc . . . for the vendor's items, is searched for and shown, and, then, the vendor selects an item with acceptable purchasing/buying information in order to implement a transaction.

The vendor-based transaction step depicted by the drawings of the present invention includes the following steps:

ST40—for providing the purchasing/buying information which most satisfies the vendor's condition.

ST41—for comparing the customer's desired price and the vendor's desired price in cases when there is information that not only satisfies the vendor's condition(s) on price, but also the customer's condition(s) on price, for searching the vendor's desired price information which is lower than the customer's desired price and for showing the customer's desired price (the customer's desired price-based system).

ST42—for helping the vendor to request for transaction verification, whenever the vendor either is satisfying or has satisfied one of the conditions provided by the transaction system.

ST43—for helping the vendor to request for new purchasing/buying information from the system, if the vendor is not satisfied with the price provided by the system.

ST44—for searching system-wide for purchasing/buying information, which satisfies the next condition.

When the system is unable to provide purchasing/buying information with respect to the information provided by the vendor, the system displays the reason to the user. A transaction is implemented when the purchasing/buying information, which most satisfies the vendor's information, is provided.

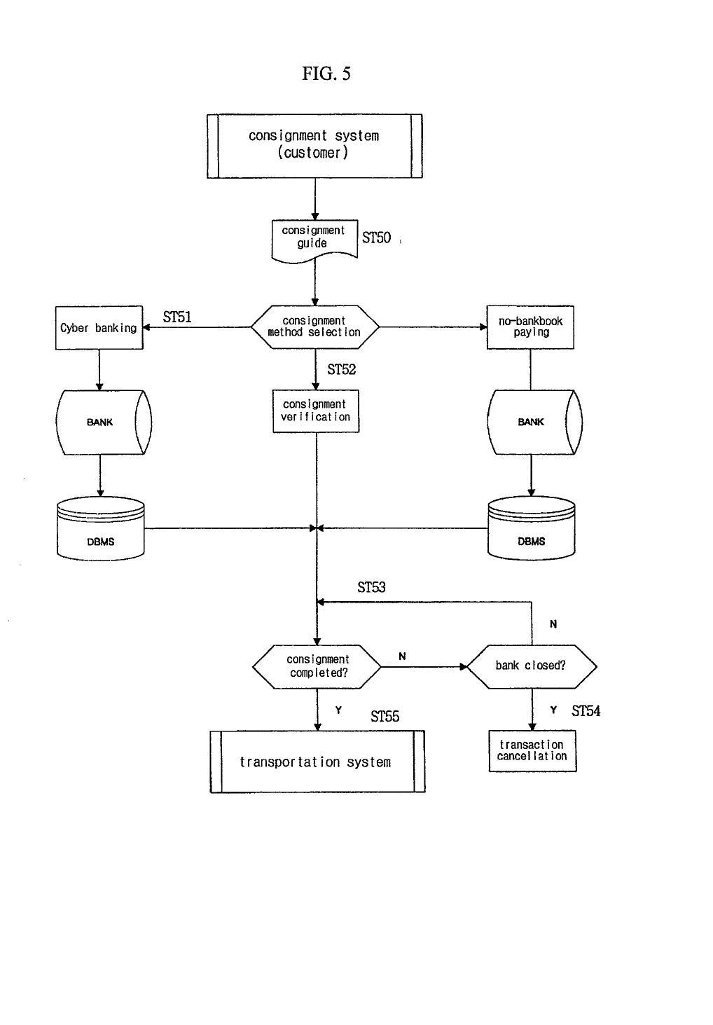

FIG. 5 is a flow chart of the customer's payment step per price of the item, after the transaction is implemented in the customer-based consignment step, according to the drawings and the related art of the present invention. As shown therein, after the transaction is implemented, the customer pays the price through a firm banking system or a no-bankbook paying system, the system verifies the payment, and, then, the item is delivered. If the monetary consignment is not implemented, the transaction is cancelled.

The customer-based consignment step includes the following steps:

ST50—for letting the user see the price per item consignment method.

ST51—for allowing the customer to selects a certain payment system from among the payment options in the cyber banking system i.e., a phone banking system, a PC banking system, etc . . . and the customer consigns the monetary amount, which is equal to the price, by using a designated consignment account.

ST52—for assisting a bank with transferring the consignment information to a corresponding step, and for switching from the consignment to the transportation step, when the price and the amount of money consigned are matched.

ST53—for providing non-match information to the customer, in cases when the price and the amount of money to be consigned are not matched.

ST54—for canceling the verified transaction, in cases when the customer does not overcome the non-matched problem pertaining to the price and the amount of money being consigned.

ST55—for switching to and initializing the transportation step, in cases when the customer accepts and the system approves the information on the price per item and the corresponding amount of money to be consigned.

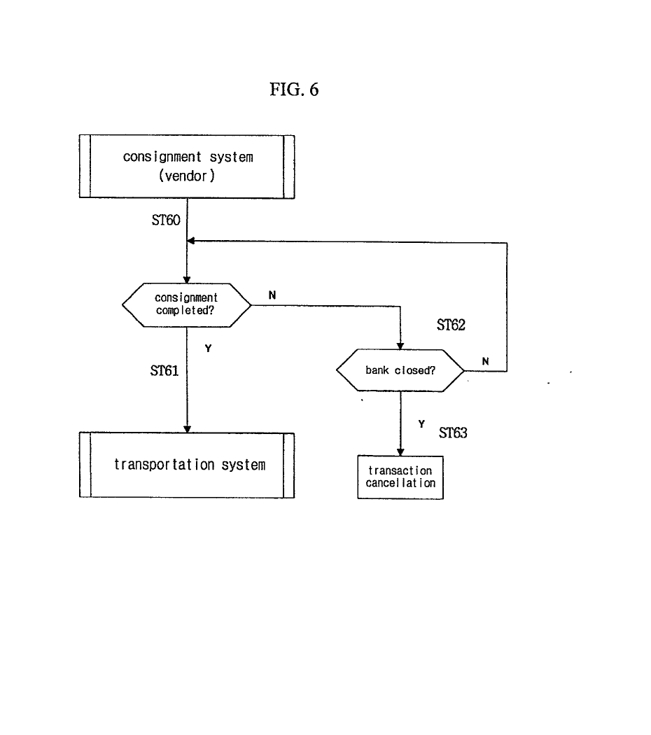

FIG. 6 is a flow chart of a vendor-based consignment step according to the drawings and the related art of the present invention. As shown therein, the information with respect to the amount of the money being consigned by the customer is shown to the vendor, so that it is possible to determine whether transaction delivery or transaction cancellation applies to the item or items in question.

The vendor-based consignment step includes the following steps:

ST60—for letting the user see the amount of the monetary consignment.

ST60—for switching to the transportation step, after the consigned monetary amount and the price of the item are matched.

ST62—for when the steps are in the standby mode until the amount of the money being consigned and the price of the item are matched, and for when in the amount of money being consigned and the price of the item are not matched before the closing time of the bank being utilized for the transaction.

ST63—for switching the step to the transportation step when the consigned amount of money consigned is matched with the price of the item, and for canceling the transaction when the amount of money consigned is not matched with the price of the money before the closing time of the bank.

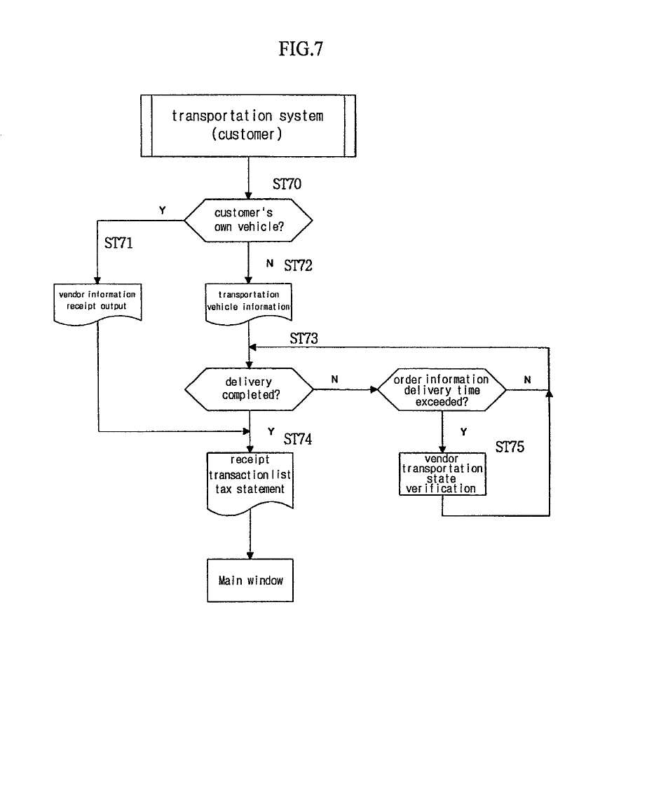

FIG. 7 is a flow chart of a customer-based transportation step according to the drawings and related art of the present invention. The customer-based transportation step accesses a customer transportation step for an item delivery, after the transaction is completed and the consignment for the price of the item has been completed, as well.

The customer-based transportation step includes the following steps:

ST70—for checking whether the customer has his own means of transportation.

ST71—for showing information about the vendor, about the company that fabricated the item, and about item to be transported in cases where the customer has his/her own means of transportation, and for issuing a receipt which certifies the delivery of the item.

ST72—for providing information, such as the driver's name, the amount of the item(s), and the delivery number of either the vendor or of the means of transportation being used by the vendor in cases where the vendor does not have his/her own means of transportation.

ST73—for requesting information, with respect to whether the item has been delivered to the customer, by checking the means of transportation.

ST74—for providing a structured document: a receipt, a tax statement, a transaction list, etc . . . which the customer desires to receive, while the customer is checking the results of the transaction.

ST75—for checking on the delivery of the item or items to the customer, and for checking the delivery schedule of either the vendor or the means of transporta-tion being utilized by the vendor in the cases when the delivery time, which is stored in the customer order information, is exceeded.

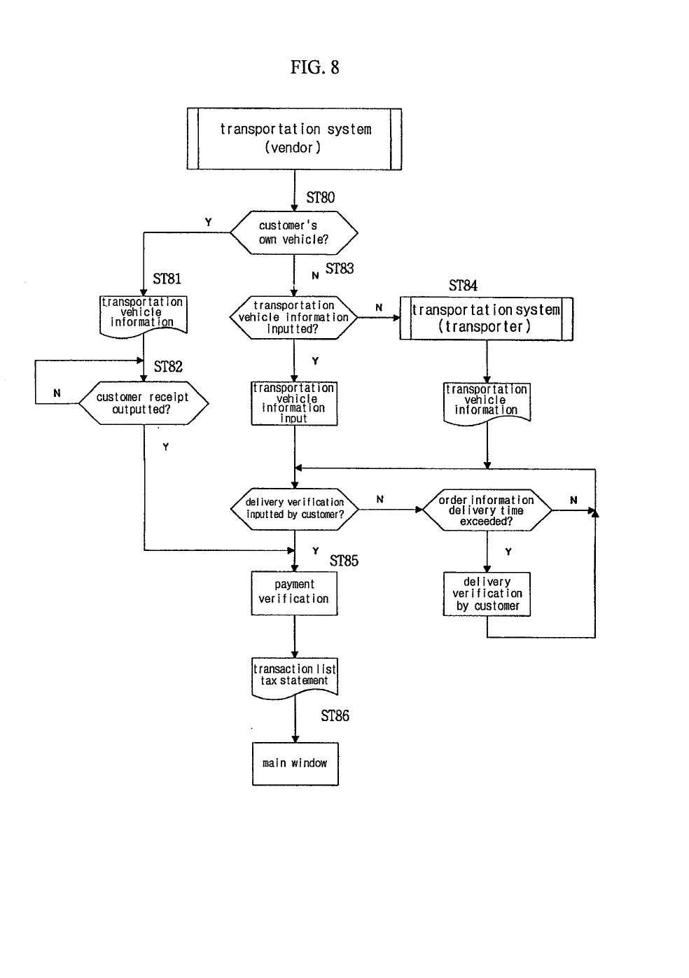

FIG. 8 is a flow chart of a vendor-based transportation step according to the drawings and the related art of the present invention. The vendor-based transportation step accesses the item to be delivered, after the transaction and the monetary consignment for the price of the item are completed.

The vendor-based transportation step includes the following steps

ST80—for checking whether or not the customer has his/her own means of transportation, based on the information that was inputted by the customer.

ST81—for checking information, such as the driver's name, the delivery No, etc . . . with respect to the means of transportation being used by the customer in the cases when the customer has his/her own means of transportation, and for checking the receipt from the customer, based on the items output information; information such as the fabrication company area, the output time of the item.

ST82—for paying the price of the item to the vendor, and for providing a information about the payment, when the customer outputs a receipt from the system.

ST83—for checking whether the vendor has his/her own means of delivery in cases when the customer does not have his/her own means of transportation.

ST84—for the input of the means of transportation, in cases where the vendor delivers the item using his/her own vehicle, and for switching the system to the transportation system (transportation company) in cases when the vendor does not have his/her own vehicle for the delivery.

ST85—for the payment of the price for the item to the vendor, after the delivery of the item has been completed.

ST86—for providing a structured document: a transaction list, a receipt, a tax statement etc . . . after the payment of the money.

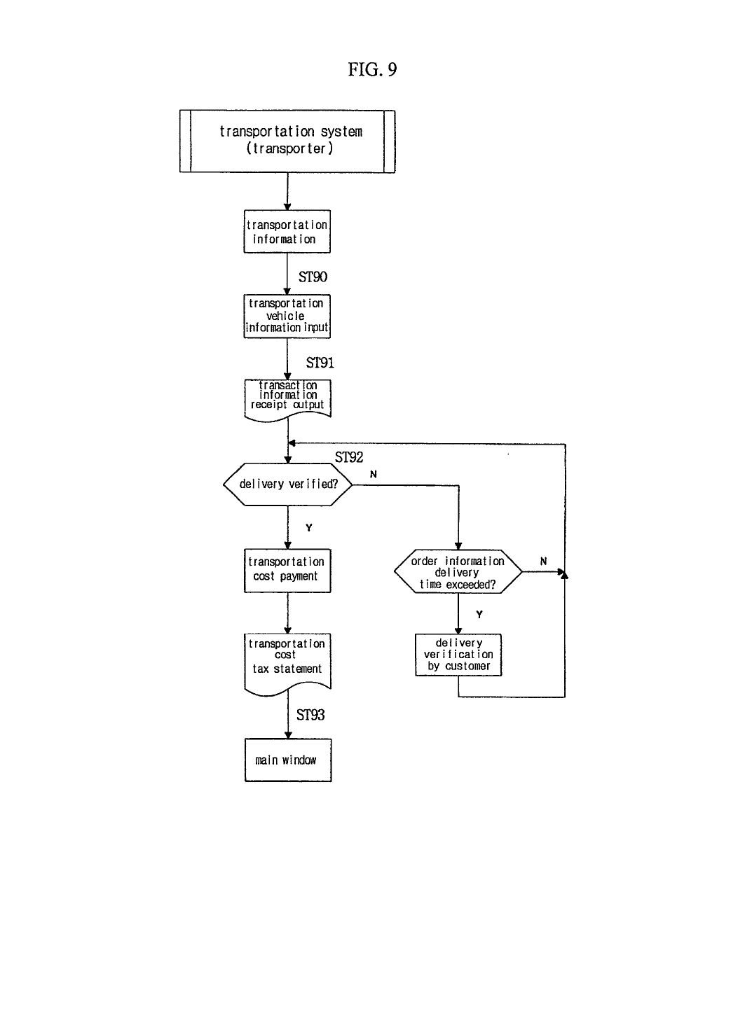

FIG. 9 is a flow chart of a transporter-based transportation step, according to the drawings and the related art of the present invention. As shown therein, the transporter-based transportation step directs the user to the delivery of an item, which will use an external means of transportation, in cases when both the vendor and the customer do not have their own means of transportation.

The transporter-based transportation step includes the following steps:

ST90—for the input of the means of transportation, used by the transportation company, after the system has output transaction information about the vendor/customer.

ST91—for issuing a receipt, needed during transportation, which includes the transaction information.

ST92—for the system to make the payment of the fee charged for the transportation of the item(s)by checking the services of the transportation company, and by having the customer check the item(s).

ST93—for placing the system in a standby mode until the delivery of the item is completed, in cases when the delivery of the item(s) is not checked, and when a structured document; such as a transportation fee tax statement, which is needed by the transportation company, is provided after the delivery is completed, and after the transportation fee is paid.

In the transactions of the products, described above, an item transaction, input by multiple users, is implemented under the same condition(s) as the condition(s) used by a vendor, so that it is possible to overcome a delivery payment problem for an item or items and to overcome a delivery problem, by preventing unstable transactions from taking place within the system due to an exclusive condition proposal on an off-line transaction system.

In addition, it is possible to support all possible transactions in the system, according to all the available information on the present invention, by providing a structured document, which is needed for both the customer and the vendor.

Although the preferred embodiment of the present invention have been disclosed for illustrative purposes, those skilled in the art will appreciate that various modifications, additions and substitutions are possible, without departing from the scope and spirit of the invention as recited in the accompanying claims.

What is claimed is:

1. A transaction method using a bi-directional optimum transaction system for multiple customers by Internet, comprising:
a customer-ordering step for the input of purchasing/buying information with respect to an item, which is desired to be purchased at an acceptable price and for providing the purchasing/buying information to the transaction system;
a vendor-ordering step for the input of vendor information with respect to supplying a certain amount of the items at a certain price and for providing the ordering information from the vendor to the transaction system;
a customer-based transaction step for searching vendor information that most closely corresponds to a purchasing/buying condition i.e. kinds, amount, delivery state, delivery time, price, etc . . . of an item that the customer wishes to buy, for showing the information obtained by the system after conducting a system-wide search, for selecting an item for transaction with respect to the purchasing/buying information by the customer, and for implementing a transaction;
a vendor-based transaction step for searching purchasing/buying information that most closely corresponds to the condition(s), such as kinds, amount, delivery state, delivery time, price, etc. of a certain item, by the vendor, for showing information obtained by the system after conducting a system-wide search, for selecting an item for transaction with respect to the purchasing/buying information by the vendor, and for implementing a transaction;
a customer-based consignment step for implementing a payment for the price of the item(s) after the transaction;
a vendor-based consignment step for selecting delivery or transaction cancellation, with respect to the item, by showing the amount of money consigned by the customer;
a customer-based transportation step for delivering the item, after the transaction is implemented, and after the money, corresponding to the price of the item, is consigned.
a vendor-based transportation step for delivering the item, after the transaction is implemented, and after the money, corresponding to the price of the item, is consigned; and
a transporter-based delivery step for transporting the item, using an external means of transportation, in cases when the customer/vendor does not have his/her own means of transportation, after the transaction is implemented, and after the money, corresponding to the price of the item, is consigned.

2. The method of claim 1, wherein said customer-based ordering step includes:
a step ST10 in which a customer registers on a main window;
a step ST11 in which the customer logs-in to the system using a verified ID, password, verification card in order to input purchasing/ buying order information;
a step ST12 in which the customer inputs an item, amount, buying time, delivery time, etc., and the purchasing/buying order information of the customer is inputted, or the ordering information is checked, modified, or deleted from the previously registered standby purchasing/buying information; and
a step ST13 in which a specific vendor, which satisfies the purchasing/buying condition(s) that were input by the customer in the system, is searched: transaction verification, and the condition(s) with respect to the ordering information are changed in cases when the customer does not buy a desired item on the transaction system or when the order is cancelled (transaction cancellation), and the buying information remains stored in the system until an item, which satisfies the desired conditions, is searched for and identified (buying standby information registration).

3. The method of claim 1, wherein the said vendor ordering step includes:
a step ST20 for registering a vendor as a member;
a step ST21 in which the vendor logs-in to the system using a verified ID, password, verification card, etc. for the input of vendor order information;
a step ST22 in which the vendor inputs an item to be sold, which includes price, amount and delivery time of the item, based on a delivery method, and the order information of the vendor is inputted, then, the ordering information is checked, modified, or deleted from any previously registered standby vending information;
a step ST23 to search for a proper customer based on the conditions that were input by the vendor, and for implementing a transaction; and
a step ST24 that allows the vendor to either change or cancel the order information in cases when the item is not sold because of the condition(s) desired by the vendor is not satisfied, (transaction cancellation), and the vending information remains stored in the system until the purchasing/buying information which satisfies the condition(s) desired by the vendor are provided (standby vending information registration).

4. The method of claim 1, wherein the said customer-based transaction step includes:
a step ST30 for searching the remaining conditions from among the desired purchasing/buying condition(s) of the customer and from among the desired condition(s) contained in the vendor's standby list;
a step ST31 for the information pertaining to a non-match, in cases when none of the standby vendor items match with the condition(s) of the step ST30;
a step ST32 in which a transaction is implemented; provided that when there are a plurality of vendors, the previously transacted company is excluded, when the purchasing/buying condition(s) of the customer are matched with the standby vendor condition(s) in the step ST30 (customer price≧vendor price);
a step ST33 in which the customer provides the vending information that most closely corresponds to the next candidate's condition(s) for the item(s), when the system does not provide any acceptable condition(s);
a step ST34 for verifying the transaction, when the customer satisfies a new condition; and
a step ST35 for either registering into the standby buying information of the system or for canceling a purchasing/buying request, when the customer does not satisfy a new condition.

5. The method of claim 1, wherein the said vendor-based transaction step includes:
a step ST40 for providing purchasing/buying information that most closely corresponds to the condition(s) of the vendor;
a step ST41 in which the system compares the desired purchase or buying price of the customer with the desired price of the vendor, in cases where corresponding information exists between the vendor's supply and delivery condition(s) and the purchasing/buying condition(s) of the customer, searches for information about a vendor's desired price that is not higher than the customer's desired price, and shows the price suggested by the customer (i.e. transaction based on the customer's preference );
a step ST42 in which the vendor verifies a transaction, in cases when the vendor is satisfied with the price provided by the system;
a step ST43 in which the vendor requests for new information from the system, in cases when the vendor is not satisfied with the price provided by the system; and
a step ST44 for searching the purchasing/buying information that most closely corresponds to the condition(s) of the next candidate and showing the information that was obtained from the search.

6. The method of claim 1, wherein said customer-based consignment step includes:
a step ST50 in which the system suggests an price per item(s) consignment method;
a step ST51 in which a customer can select a desired consignment method from among the options provide by cyber banking i.e. phone bankng, PC banking etc . . . and the customer consigns the amount of money, which corresponds to the transaction price, based on the designated consignment account, when the method of consignment is determined;
a step ST52 in which the bank reports the consignment information to the system during the consignment process, and the system is switched to the transportation step from the consignment step, when the item(s) price and the amount of money are matched;
a step ST53 for continuously providing information to the customer with respect to non-matched information, when the item(s) price and the amount of money to be consigned are not matched;
a step ST54 in which the system cancels the verified transaction when the customer does not remove non-matching information between the item(s) price and the amount of the money being consigned; and
a step ST55 in which the system is switched to the transportation step, when the customer removes a non-matching problem status, based on information with respect to the non-matching status between the item(s) price and the amount of the money being consigned.

7. The method of claim 1, wherein the said vendor-based consignment step includes:
a step ST60 for showing information with respect to the monetary consignment;
a step ST61 in which the system is switched to the transportation step, when the amount of the monetary consignment and the item(s) price are matched;
a step ST62 in which the system is switched to the standby mode, before the closing time of the bank being utilized for the transaction, and when the amount of the monetary consignment is not matched with the item(s) price; and
a step ST63 for switching the system to the transportation step, when the amount of the monetary consignment is matched with the item(s) price, and when the system cancels the transaction because the amount of money to be consigned is not matched with the item(s) price after the closing time of the bank to be utilized for the transaction.

8. The method of claim 1, wherein the said customer-based transportation step includes:
a step ST70 for checking whether the customer has his/her own means of transportation;
a step ST71 in which the system shows information on the vendor, on the company which is responsible for the fabrication of the item(s), and on the item(s) to be transported in cases when the customer has his/her own means of transportation, and a receipt is issued which certifies the delivery of the item;
a step ST72 in which the system provides information, such as the driver's name, the amount of the item, and the delivery No. of a vendor or of the transportation company with respect to its agreed upon means of transportation, in cases where the vendor does not have his/her own means of transportation;
a step ST73 in which the system requests for information, with respect to whether the item has been delivered to the customer, by checking the means of transportation being used for the item(s);
a step ST74 in which the system provides a structured document: a receipt, a tax statement, a transaction list, etc . . . which the customer desires to receive while the customer is checking the results of the transaction; and
a step ST75 in which the delivery to the customer is checked, and the delivery schedule of the transportation company of the vendor is checked, in cases when the delivery time, stored in the customer order information, has been exceeded.

9. The method of claim 1, wherein the said vendor-based transportation system includes:
a step ST80 in which information, with respect to the customer and the customer order, is checked in order to determine whether the customer has his/her own means of transportation;
a step ST81 in which information, such as the driver's name, the delivery No., is checked with respect to the means of transportation, when the customer has his/her own transportation means, and the customer outputs a receipt, which is based on the item(s) of the outputted information, i.e. the consignment destination, the consignment time etc . . . that is checked as well;
a step ST82 in which when the customer outputs a receipt, the system remits the payment of the item to the vendor, and the system provides information on the payment;
a step ST83 in which the vendor checks whether the vendor has his/her own means of delivery, in cases where the customer does not have his/her own means of transportation;
a step ST84 in which an information on the means of transportation is input to the system, in cases when the vendor delivers the item using his own vehicle, and the system is switched to the transportation step (in regard of the transportation company), in cases when the vendor does not have his/her own vehicle for the delivery;
a step ST85 in which the system pays the price of the item to the vendor when the delivery of the item is completed; and
a step ST86 for providing a structured document, such as a transaction list, a receipt, a tax statement, etc. after the payment of the money.

10. The method of claim 1, wherein the said transporter-based transportation step includes:
a step ST90 in which a transportation company inputs the information on the means of transportation, when the system outputs transaction information of the vendor/customer;
a step ST91 in which the system issues a receipt, including transaction information needed during the transportation of the item(s);
a step ST92 in which the system pays the fee for the transportation of the item(s),by checking the services provided by the transportation process, and the customer checks the item; and
a step ST93 in which the system is placed in a standby mode until the delivery of the item is completed, in cases when the delivery is not checked, and a structured document; such as a transportation fee, tax statement etc . . . , which is needed by the transportation company, is provided, after the delivery is completed, and after the transportation fee is paid.
